(19) United States
(12) Patent Application Publication
(10) Pub. No.: US 2010/0046109 A1
(43) Pub. Date: Feb. 25, 2010

(54) INFORMATION STORAGE APPARATUS AND REPRODUCTION METHOD

(75) Inventor: Nobuhide Aoyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/482,268

(22) Filed: Jun. 10, 2009

(30) Foreign Application Priority Data
Aug. 20, 2008 (JP) 2008-212258

(51) Int. Cl. G11B 5/02

(52) U.S. Cl. 360/55; G9B/5.026

(57) ABSTRACT

An information storage apparatus includes: a recording medium on which first information is recorded by a physical arrangement of magnetic bits and second information is recorded by magnetizing the magnetic bits; a first reproduction part that reads third information including the first information and the second information; an erasing part that erases the second information that is recorded on the information recording medium and is related to the third information read by the first reproduction part; a second reproduction part that reads the first information from the magnetic bits from which the second information is erased by the erasing part; and an information obtaining part that obtains the second information from the first information and the third information respectively read by the first and second reproduction parts.

### CROSS-REFERENCE TO RELATED APPLICATION

This application is based upon and claims the benefit of priority of the prior Japanese Patent Application No. 2008-212258, filed on Aug. 20, 2008, the entire contents of which are incorporated herein by reference.

### FIELD

A certain aspect of the embodiments discussed herein is related to an information storage apparatus and a reproduction method.

### BACKGROUND

Recently, a hard disk drive (HDD) has been widely used as a storage apparatus in a personal computer and an HDD recorder. The recording density of the hard disk is approximately doubled per year and is now about 1000 times the recording density that was available ten years ago.

There is a recent trend to employ vertical magnetic recording rather than horizontal magnetic recording in order to improve the recording density. Furthermore, there has been considerable activity in the development of DTM (discrete track media) and BPM (bit pattern media) in order to further improve the recording density. Particularly, BPM has a configuration in which a disk medium is magnetically isolated in a cross track direction and a down track direction. It is thus possible to restrain cross erasure and crosstalk to adjacent tracks and to restrain transition noise in the down track direction. BPM may be implemented by transferring a fixed bit pattern (imprinting). It is thus possible to greatly reduce the steps necessary to perform STW (servo track write).

There is a proposal of a medium called BPM-ROM, which utilizes a feature of the BPM media and is capable of recording a huge amount of contents information by employing a physical arrangement of magnetic bits (a magnetic bit pattern), as illustrated in FIG. 17.

Regarding BPM and BPM-ROM capable of storing a huge amount of information, there is no proposal to realize highly reliable security against unauthorized copy or change of contents. Generally, the information storage medium employs a security system as illustrated in FIG. 18. More particularly, a system area 112 that cannot be accessed by the user is defined on an information storage medium (magnetic disk) 110. Authentication information is recorded in the system area 112. A switch 118 compares the authentication information read by a head 114 with a password applied from an external apparatus. A decoder 116 decodes contents information read from the information storage medium 110. The switch 118 allows the decoded contents information to an external apparatus when the authentication information coincides with the password.

There is another proposal to strengthen the security using magnetically fixed information that is implemented by a magnetically fixed pattern to protect the information storage medium from unauthorized copy (see Japanese Laid-Open Patent Application No. 2006-260713).

According to the above proposal, contents information remain in the information storage medium except a particular case after contents information is read. Of course, contents information may be erased after the contents information is read. However, in this case, the user does not have any way to confirm that contents information have been duly erased, and there is a possibility that remaining contents information may be read by spoofing. Thus, the reliability of security is not high.

### SUMMARY

According to an aspect of the present invention, there is provided an information storage apparatus including: a recording medium on which first information is recorded by a physical arrangement of magnetic bits and second information is recorded by magnetizing the magnetic bits; a first reproduction part that reads third information including the first information and the second information; an erasing part that erases the second information that is recorded on the information recording medium and is related to the third information read by the first reproduction part; a second reproduction part that reads the first information from the magnetic bits from which the second information is erased by the erasing part; and an information obtaining part that obtains the second information from the first information and the third information respectively read by the first and second reproduction parts.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan view of an HDD in accordance with an embodiment of the present invention;

FIG. 2 is a block diagram of a control system of the HDD illustrated in FIG. 2;

FIG. 3 schematically illustrates an exemplary structure of a magnetic disk;

FIG. 4 is a flowchart of a method for manufacturing a magnetic disk;

FIG. 5 is a block diagram of an electron beam exposure apparatus used to produce a BPM master disk;

FIG. 6 illustrates an arrangement of recording bits formed on the magnetic disk;

FIG. 7 is a block diagram of an exemplary configuration that writes information in the magnetic disk;

FIG. 8 is a block diagram of an exemplary structure of an operation part of the configuration illustrated in FIG. 7;

FIG. 9 is a flowchart of a process for writing information in the magnetic disk;

FIG. 10A schematically illustrates a situation in which no information is magnetically recorded in recording bits, and FIG. 10B schematically illustrates a situation in which information is magnetically recorded in recording bits;

FIG. 11 is a block diagram of an exemplary configuration that reads information from the magnetic disk;

FIG. 12 is a block diagram of an exemplary configuration of the operation part shown in FIG. 11;

FIG. 13 is a flowchart of a process for reading information from the magnetic disk;

FIG. 14A illustrates recording bits and a waveform of a signal reproduced from magnetically recorded bits, and FIG. 14B illustrates recording bits and a waveform of a signal that is obtained from the signal illustrated in FIG. 14A and is indicative of a physical arrangement of recording bits;

FIG. 15 is a graph of a normalized output vs bit inversion pitch characteristic;

FIG. 16 illustrates a basic recording bit length of magnetically recorded information, and a basic recording bit length of ROM information;

FIG. 17 illustrates an arrangement of a patterned bit of a BMP medium; and

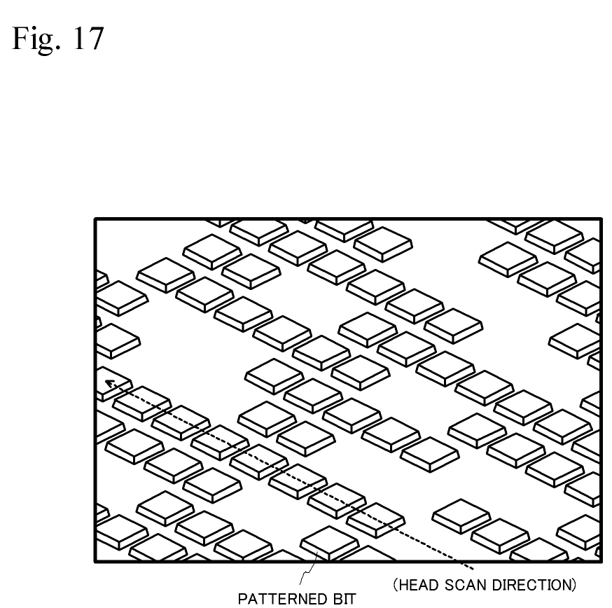

FIG. 18 is a block diagram of a configuration involved in reading information from an information storage medium such as a magnetic disk.

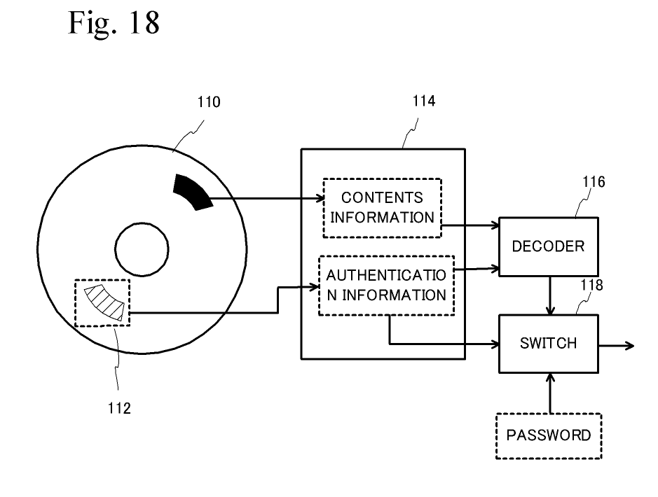

### DESCRIPTION OF EMBODIMENTS

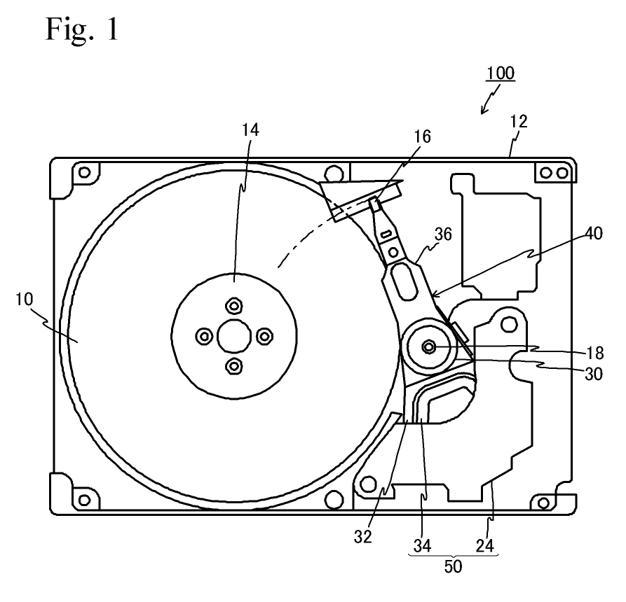

A description will now be given, with reference to FIGS. 1 through 16, of an information storage apparatus in accordance with an embodiment.

FIG. 1 illustrates an internal structure of a hard disk drive (HDD), which is an exemplary device 100 of the magnetic storage apparatus in accordance with the embodiment. As illustrated in FIG. 1, the HDD 100 is equipped with a box-like enclosure 12, a magnetic disk 10, a spindle motor 14, and a head stack assembly 40. The magnetic disk 10 is a magnetic storage medium and is housed in a space in the enclosure 12. The enclosure 12 may be composed of a base and an upper lid or top cover. The upper lid is not illustrated in FIG. 1 for the sake of convenience.

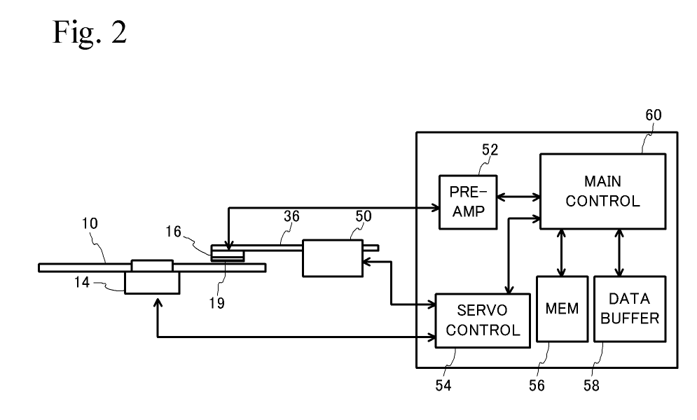

The magnetic disk 10 has a recording plane on the front surface, and is driven to rotate at a velocity, which may, for example, be as high as 4200-15000 rpm. The spindle motor 14 may be rotated by a servo controller 54 under the control of a main control unit 60 illustrated in FIG. 2. The magnetic disk 10 may have another recording plane on the back surface. A plurality of magnetic disks may be provided in the direction perpendicular to the drawing sheet.

The head stack assembly 40 has a housing 30 of a hollow cylindrical shape, a fork 32, a coil 34, a carriage arm 36, and a head slider 16. The fork 32 is fixed to the housing 30. The coil 34 is held by the fork 32. The carriage arm 36 is fixed to the housing 30. The head slider 16 is held by the carriage arm 36. Two sets of carriage arm and head slider are symmetrically arranged vertically across the magnetic disk having the recording planes on the front and back sides thereof. When the hard disk drive has multiple recording disks, one set of carriage arm and head slider is provided for each recording plane of each magnetic disk.

The carriage arm 36 may be formed by cutting a stainless plate or pressing an aluminum member. The head slider 16 has a recording and reproduction head 19 composed of a recording element and a reproduction element. In the following description, the recording and production head 19 may be referred to as head simply. The head is also illustrated in FIGS. 2, 7 and 11. The head 19 is used for vertical magnetic recording and reproduction.

The head stack assembly 40 is rotatably joined to the housing 30 by a bearing member 18 provided at the center of the housing 30. A voice coil motor 50 causes the carriage arm 36 to swing about the bearing member 17. The voice coil motor 50 is composed of the coil 34 and a magnetic pole unit 24 including a permanent magnet fixed to the enclosure 12. The voice coil motor 50 is driven by the servo controller 54 under the control of the main control unit 60. The swing movement of the carriage arm 36 is illustrated by a one-dot chained line in FIG. 1.

FIG. 2 is a block diagram of a control system of the HDD 100. The control system of the HDD 100 includes a pre-amplifier 52, the above-described servo controller 54, the above-described main control unit 60, a memory (MEM) 56 and a data buffer memory 58. The pre-amplifier 52 is connected to the head 19. The servo controller 54 is connected to the spindle motor 14 and the voice coil motor 50. The main control unit 60 is involved in overall control of the pre-amplifier 52, the servo controller 54, the memory 56 and the data buffer memory 58. The memory 56 and the data buffer memory 58 are connected to the main control unit 60.

The HDD 100 thus configured writes and reads data in and from the magnetic disk 10 by the head 19 via the pre-amplifier 52 under the control of the main control unit 60. The head slider 16 that holds the head 19 flies over the magnetic disk 10 due to the coercive force generated by rotation of the magnetic disk 10. The head 19 writes and reads data in and from the magnetic disk 10 while a slight gap is maintained between the head 19 and the magnetic disk 10. The voice coil motor 50 controlled by the servo controller 54 swings the carriage arm 36 so that the magnetic head 19 can be moved across the tracks to seek a target track for recording or reproduction.

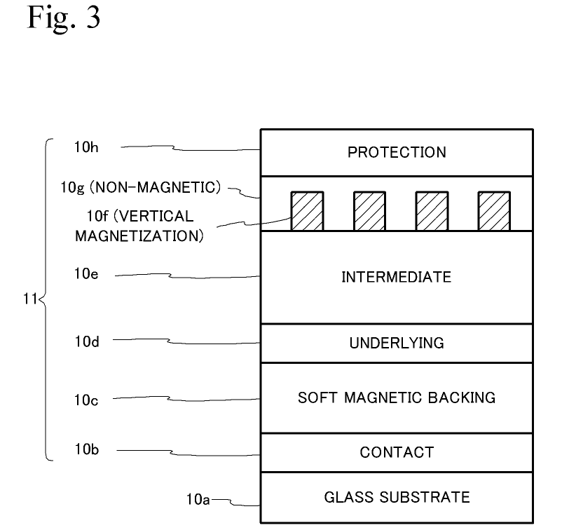

The magnetic disk 10 may have a structure as illustrated in FIG. 3.

FIG. 3 schematically illustrates a multilayered structure of the magnetic disk 10. The magnetic disk 10 has a glass substrate 10a, and a multilayered portion 11.

The glass substrate 10a may be a crystallized glass substrate or a reinforced glass substrate. The multilayered portion 11 has a contact layer 10b, a soft magnetization backing layer (SUL: soft under layer) 10c, an underlying layer 10d, an intermediate layer 10e, a vertical magnetization layer 10f, a nonmagnetic layer (metal filled layer) 10g and a protection layer 10h. The vertical magnetization layer 10f has recording bits, and may be made of, for example, a Co alloy such as CoCr, CoPt, CoCrPt, or CoCrTa. A lubrication layer (not shown) is provided on the surface (upper surface) of the protection layer 10h.

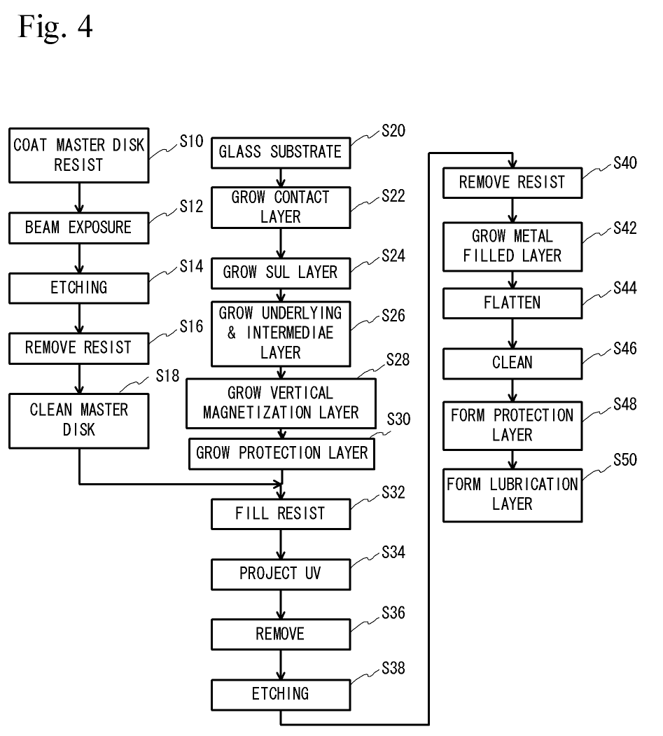

The magnetic disk 10 may be produced by a process as illustrated in FIG. 4.

First, a BPM master disk is produced. The BPM master disk is used to form a pattern on the magnetic disk 10 (more particularly, to form recording bits in the vertical magnetization layer 10f). The process prepares a substrate (master disk) of BPM. At step S10, the surface of the BPM master disk is coated with resist that is approximately 10 nm thick. At step S12, electron beam exposure is carried out.

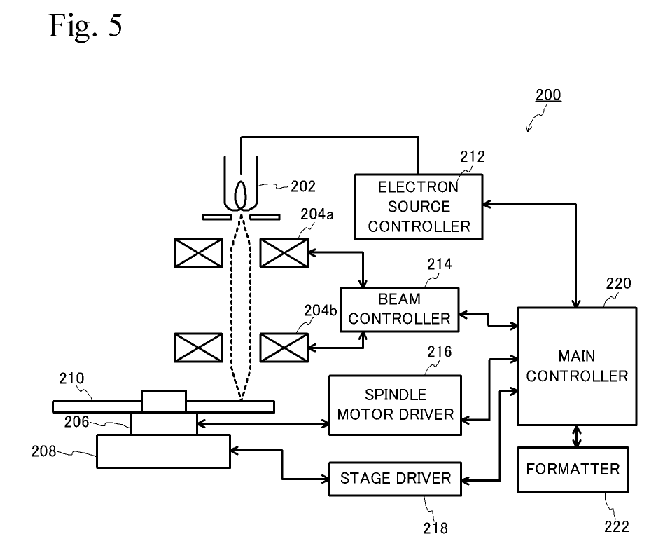

The electron beam exposure uses an electron beam exposure apparatus 200 as illustrated in FIG. 5. The apparatus 200 has a two-dimensional stage 208, a spindle motor 206, an electron source 202, an electron beam adjustment system 204a, and an electron beam focusing system 204b. The two-dimensional stage 208 may move in the horizontal plane. The spindle motor 206 holds a master disk 210 on the two-dimensional stage 208 and rotates the master disk 210. The electron source 202 emits an electron beam to the master disk 210. The systems 204a and 204b are equipped with electromagnets. The electron beam exposure apparatus 200 has a control system, which is composed of an electron source controller 212, an electron beam controller 214, a spindle motor driver 216, a stage driver 218, and a main controller 220. The electron source controller 212 is connected to the electron source 202. The electron beam controller 214 is connected to the electron beam adjustment system 204a and the electron line focusing system 204b. The spindle motor driver 216 is connected to the spindle motor 206. The stage driver 218 is connected to the two-dimensional stage 208. The main controller 220 totally controls the above-described controllers and drivers.

An electron beam emitted from the electron source 202 is focused on the master disk 210 by means of the electron beam adjustment system 204a and the electron beam focusing system 204b. The main controller 220 drives the spindle motor 206 via the spindle motor driver 216 on the basis of information from a formatter 222, and thus adjusts the rotational position of the master disk 210. Further, the main controller 220 drives the two-dimensional stage 208 via the stage driver 218, and adjusts the position of the master disk 210 with respect to the position at which the electron bean is focused. Furthermore, the main controller 220 quickly modulates the intensity and position of the electron beam via the electron source controller 212 on the basis of the information from the formatter 222, and records bit information on the master disk 210.

After the electron beam exposure is carried out in the above-described manner, etching for the master disk 210 is carried out at step 14. Thus, a concave-convex pattern corresponding to the bit pattern (recording bits) to be formed on the magnetic disk 10 are formed.

Thereafter, the resist is removed by ashing or the like at step S16, and the master disk is cleaned at step S18. Thus, the BPM master disk is completed.

The magnetic disk 10 may be produced by a process composed of steps S20 through S50 illustrated in FIG. 4. First, the glass substrate 10a of the magnetic disk 10 at step S20. Next, the multilayered structure is formed on the glass substrate 10a by serially forming the contact layer 10b, the SUL layer 10c, the underlying layer 10d, the intermediate layer 10e, the vertical magnetization layer 10f and the protection layer 10h by sputtering at steps S22 through 30, respectively. At step S32, resist for use in nanoimprint is applied to the glass substrate 10a with the layers thus stacked by using the BPM master disk produced by the steps S10 through S18. After that, UV is projected at step S34. At step S36, the BPM master disk is removed. At step S38, etching is carried out for the resist bits thus formed, and the resist is removed by ashing at step S40. Thus, a bit pattern of recording bits is formed on the glass substrate 10a.

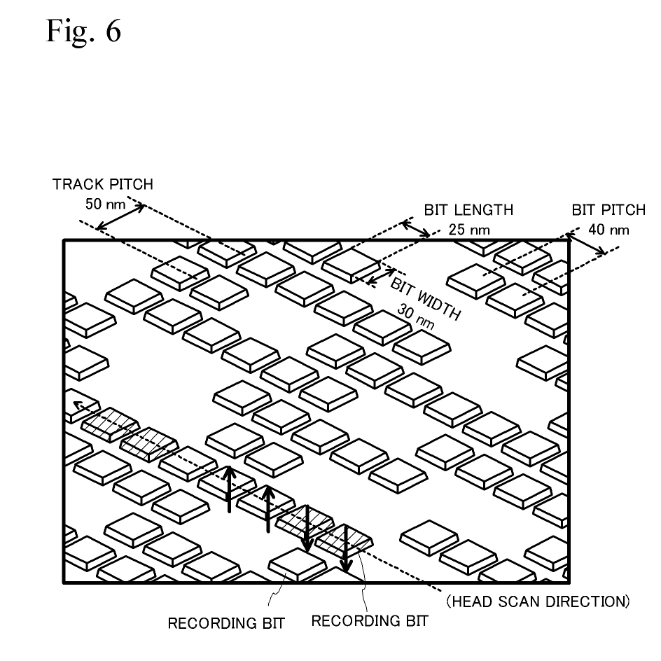

At step S42, the nonmagnetic layer 10g (see FIG. 3) filled with a metal is grown on the glass substrate 10a on which the bit pattern (recording bits) is formed. At subsequent step S44, the magnetic disk 10 is flattened by reverse sputtering. At step S46, the glass substrate 10a is cleaned. The protection layer 10h is formed at step S48, and the lubrication layer (not illustrated) is formed by coating a lubrication agent at step S50. Thus, the magnetic disk 10 is completed. The magnetic disk 10 thus formed has a bit pattern composed of recording bits as illustrated in FIG. 6. Each bit is 25 nm long in the down track direction in which the head travels for scan, and is arranged at a minimum bit pitch of 40 nm in the down track direction. Each bit is 30 nm long in the cross track direction (in other words, a bi width of 30 nm), and is arranged at a track pitch of 50 nm in the cross track direction.

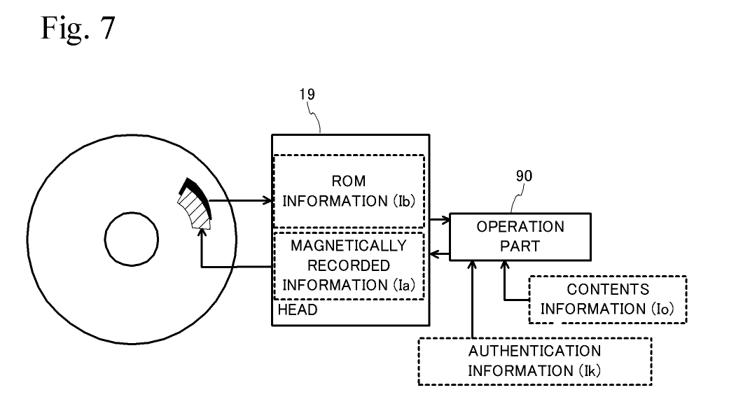

Contents information may be recorded on the magnetic disk 10 by a recording method, which will be described with reference to FIGS. 7 through 10.

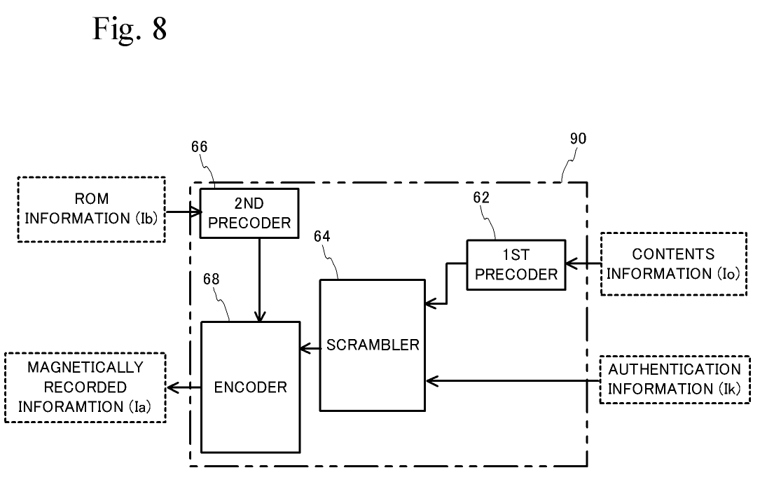

In the present embodiment, as illustrated in FIG. 7, an operation part 90 included in the main control unit 60 uses contents information Io and authentication information Ik as second information, and ROM information Ib as first information, and generates magnetically recorded information Ia as third information from the first information and the second information. The magnetically recorded information Ia is recorded on the magnetic disk 10 using the head 19. In practice, recording the information Ia on the magnetic disk 10 means that contents information Io and the authentication information Ik are magnetically recorded in the recording bits on the magnetic disk 10. As depicted in FIG. 8, the operation part 90 in FIG. 7 is composed of a first preencoder 62, a scrambler 64, a second preencoder 66 and an encoder 68.

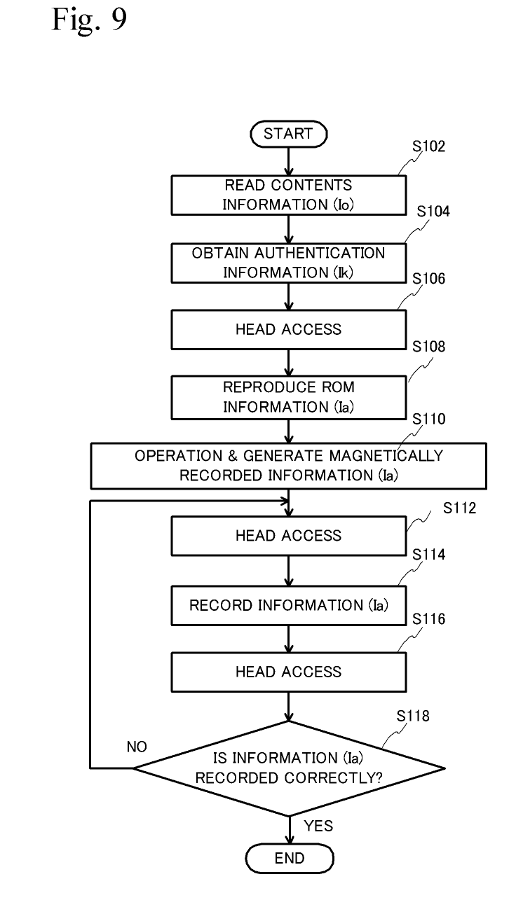

FIG. 9 is a flowchart of a process for magnetically recording information Ia by the main control unit 60 including the operation part 90. At step S102, the main control unit 60 reads contents information Io supplied from an external apparatus and stores the contents information Io in the data buffer memory 58. At step S104, the main control unit 60 reads the authentication information Ik from the memory 56 depicted in FIG. 2, and stores the authentication information Ik in the data buffer memory 58.

At subsequent step S106, the servo controller 54 drives the voice coil motor 50 under the control of the main control unit 60 to move the head 19 to the position at which contents information should be written. At step S108, the main control unit 60 obtains ROM information Ib via the head 19. The ROM information Ib is information based on the physical arrangement of recording bits formed on the magnetic disk 10.

At step S110, the main control unit 60 (more particularly, the operation part 90) operates the magnetically recorded information Ia using the pieces of information Io, Ik and Ib. In this operation, the contents information Io is preencoded by the first preencoder 62 of the operation part 90. The preencoded contents information Io and the authentication information Ik are scrambled by the scrambler 64. The ROM information Ib preencoded by the second preencoder 66 is added to the scrambled information and is then encoded by the encoder 68, so that the magnetically recorded information Ia can be generated. The structure illustrated in FIG. 8 is an exemplary operation, and another operation structure may be employed.

Turning back to FIG. 9, at step S112, under the control of the main control unit 60, the servo controller 54 drives the voice coil motor 50 to move the head 19 to the aforementioned position at which the contents information should be written. At subsequent step S114, the information Ia is magnetically recorded using the head 19.

The magnetically recorded information Ia is recorded at the same position as the ROM information Ib. More particularly, the ROM information Ib and the magnetically recorded information Ia are managed on the sector base, and are associated with each other for each sector.

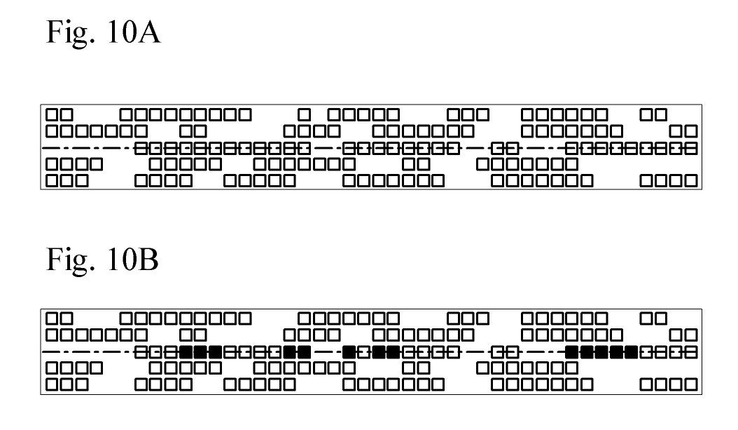

In the present embodiment, the recording bits that form the ROM information Ib are arranged at a pitch equal to or greater than twice the minimum bit pitch, and information may be obtained from variations of the pitch equivalent to the number of bits arranged in the scanning direction. In contrast, the magnetically recorded information Ia is recorded by variations in the pattern of recording bits in the magnetized direction. Since the present embodiment employs the vertical magnetic recording, the information Ia is magnetically recorded by a variation in the pattern of recording bits in the magnetized direction (upwards or downwards) vertical to the plane (surface) of the magnetic disk 10. For example, it is assumed that recording bits are formed on the magnetic disk 10 with an arrangement illustrated in FIG. 10A. In this case, information Ia may be magnetically recorded as illustrated in FIG. 10B in which solid recording bits are magnetized downwards, and blank recording bits are magnetized upwards.

Turning back to FIG. 9, at subsequent step S116, the servo controller 54 drives the voice coil motor 50 to move the head 19 again to the position at which the information Ia is magnetically recorded. The main control unit 60 has a verify function, which determines whether the information Ia has been recorded correctly at step S118. When this verification indicates that the magnetically recorded information Ia has not been recorded correctly, a sequence of steps S112 through S118 is repeatedly carried out. When it is confirmed that the magnetically recorded information Ia has been recorded correctly, the process illustrated in FIG. 9 is ended.

In practice, an ECC (error correction code) is added to the information Ia to be magnetically recorded and is recorded on the magnetic disk 10.

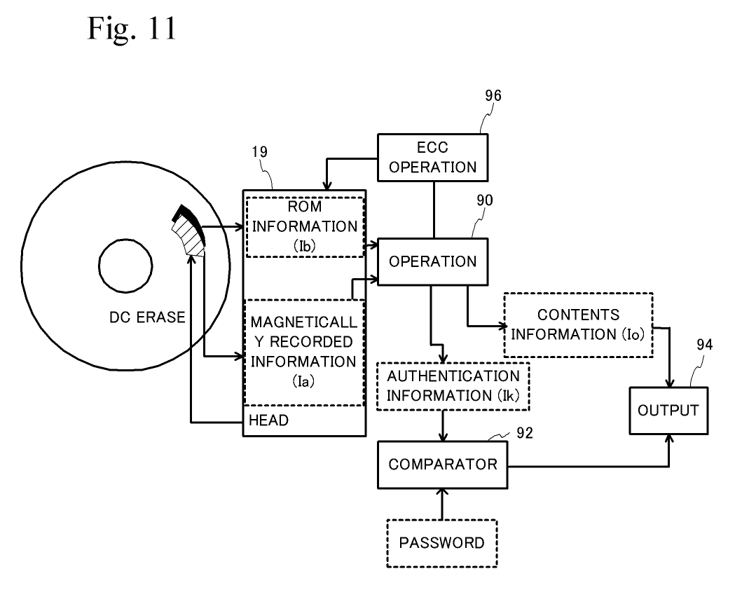

The contents information Io may be read from the magnetic disk 10 in a manner as illustrated in FIGS. 11 through 14.

The present embodiment has a configuration to read contents information Io as illustrated in FIG. 11. This configuration is composed of the operation part 90 included in the main control unit 60, a comparator 92, an output part 94, an ECC operation part 96 and the head 19. The head 19 functions as first and second reproduction or read parts, and the operation part 90 functions as an information obtaining part. The comparator 92 and the output part 94 form an output control part, and the ECC operation part 96 functions as an erasure prohibiting part.

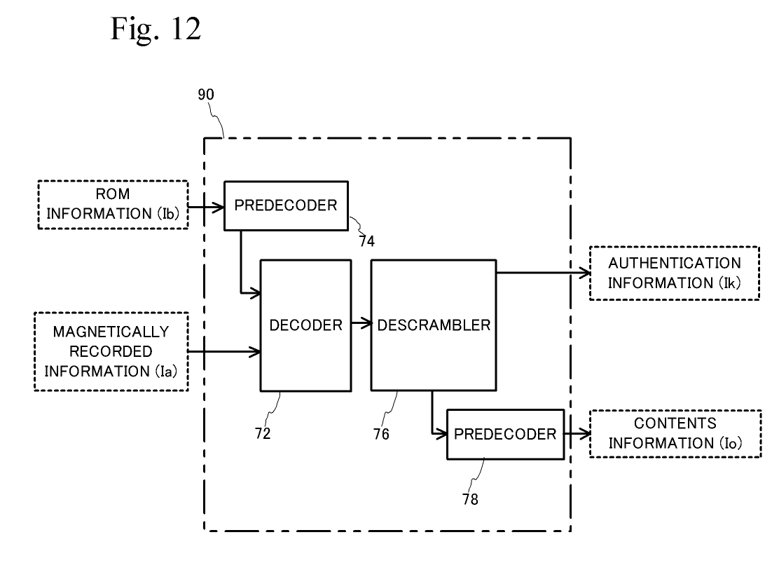

In addition to the configuration for information recording, the operation part 90 has a configuration to read information as illustrated in FIG. 12. This configuration includes a decoder 72, a predecoder 74, a descrambler 76, and a predecoder 78.

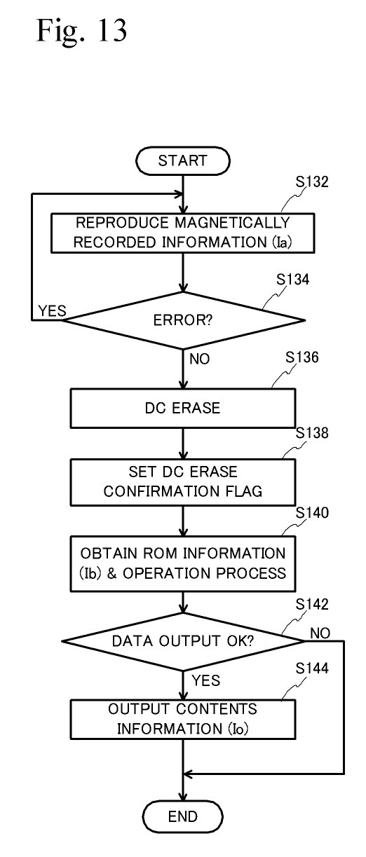

FIG. 13 is a flowchart of a process for reading or reproducing the contents information Io by the main control unit 60, which includes the operation part 90, the comparator 92, and the output part 94.

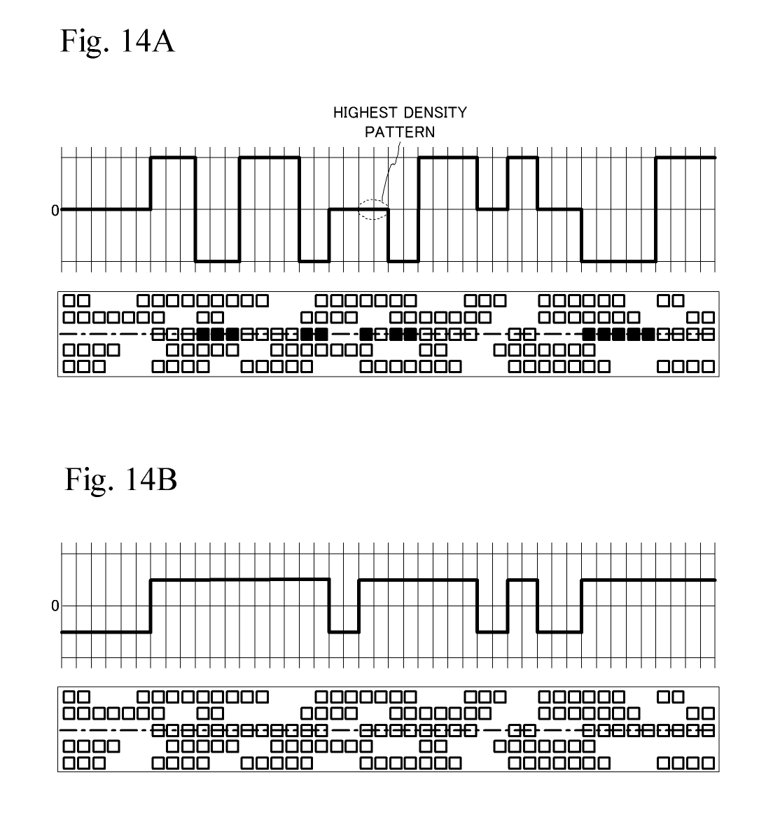

At step S132, the main control unit 60 reads the magnetically recorded information Ia by using the head 19. An example of the magnetically recorded information Ia read by the main control unit 60 is illustrated in FIG. 14A. A waveform shown in FIG. 14A is obtained by digitizing the read signal of the magnetically recorded information Ia by the comparator processing. The output waveform indicates a zero level at each recording bit in which no information is magnetically recorded. The output waveform changes in accordance with the magnetization direction of the magnetically recorded information Ia.

Turning back to FIG. 13, at step S134, the ECC operation part 96 performs an ECC operation on the reproduced data in order to determine whether there is an error in the reproduced data (in other words, an error is correctable). When it is determined that there is no error, the process returns to step S132. In contrast, when there is an uncorrectable error, the process proceeds to step S136.

At step S136, the main control unit 60 changes the magnetization direction of each bit in which the information Ia is magnetically recorded and is read by the head 19 and thus erases the recorded data (DC erasure). That is, the DC erasure is performed after the ECC operation. It is thus possible to prevent the existing recorded data from being erased when the reproduced data has an error.

At step S138, the main control unit 60 sets or activates a DC erasure confirmation flag. The setting of the DC erasure confirmation flag makes it possible to easily identify the recording bits in which data can be written in later writing of information.

At subsequent step S140, the main control unit 60 reproduces the ROM information Ib via the head 19. An exemplary waveform of the ROM information Ib is illustrated in FIG. 14B. At step S140, the main control unit 60 performs an operation on the ROM information Ib and the magnetically recorded information Ia read at step S132. In this operation, as illustrated in FIG. 12, the magnetically recorded information Ia is added to the ROM information Ib predecoded by the predecoder 74 of the operation part 90, and resultant information is decoded by the decoder 72. The decoded information is descrambled by the descrambler 76. The authentication information Ik is taken by the above descrambling process, and the remaining information is predecoded by the predecoder 78. The predecoded information is contents information Io.

At step S142, a password input by the user is applied to the comparator 92 of the main control unit 60 illustrated in FIG. 11. The comparator 92 compares the password with the authentication information Ik to thus determine whether outputting of data is allowed. When the answer of step S142 is YES, the contents information Io is output to the output part 94 at step S144, and the process in FIG. 13 is finished. When the answer of step S142 is NO, the main control unit 60 ends the process without outputting the contents information Io.

In the present embodiment, the waveform of the signal illustrated in FIG. 14A is at the zero level at positions where no recorded pattern exists, and is at a level different from the zero level at positions where a recorded pattern exists. There is an exception in which the waveform of the signal is at the zero level in a highest density pattern in which the magnetization direction is inverted every recording bit. Thus, if there is no highest density pattern, the third party may easily analyze the ROM information Ib illustrated in FIG. 14B from the information illustrated in FIG. 14A and may easily obtain the contents information Io.

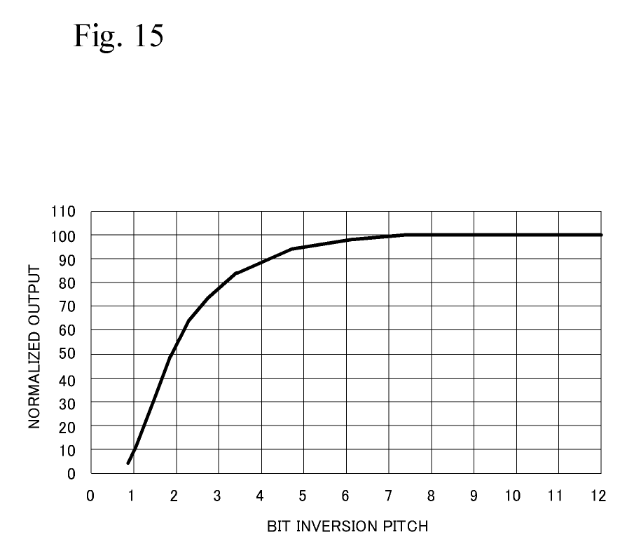

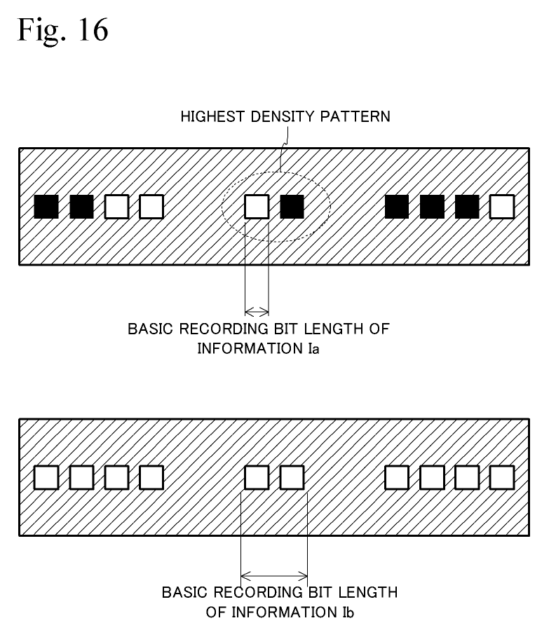

It is to be noted that the level of the output signal decreases as the bit inversion pitch narrows, as illustrated in FIG. 15. Thus, the highest density pattern as illustrated in FIG. 16 is capable of reducing the output level to about 10% of the output level of a pattern having a long inversion pitch at a normalized output of 100.

In the present embodiment, as illustrated in FIG. 16, the basic recording bit length of the ROM information Ib is set greater than the basic recording bit length of the magnetically recorded information Ia so that the highest density pattern can be defined and the output of the highest density pattern thus defined may be reduced to a level as low as noise. It is thus impossible to correctly analyze the ROM information Ib illustrated in FIG. 14B on the basis of only the information illustrated in FIG. 14A. This makes it possible to define erasure of the magnetically recorded information Ia as a condition necessary to read the ROM information Ib.

As illustrated in FIG. 16, information Ia cannot be magnetically recorded in areas having no recording bits. When the basic recording bit length of the magnetically recorded information Ia and that of the ROM information Ib are equal to each other, the amount of magnetically recorded information Ia is half that of the ROM information Ib. When either the magnetically recorded information Ia or the ROM information Ib is reduced to have an excessively small amount of information, the reduced (smaller) amount of information may easily be guessed in decoding of the magnetically recorded information Ia and the ROM information Ib. In an extreme example in which the magnetically recorded information Ia has 512 bytes and the ROM information Ib has 1 byte, the smaller amount of information, namely, the ROM information Ib may be analyzed easily.

With the above in mind, the recording density per unit area of the ROM information Ib is set approximately equal to the recording density per unit area of the magnetically recorded information Ia.

In the present embodiment, the probability of appearance of bits that form the ROM information Ib is set equal to ½ under the condition that the basic recording bit length of the ROM information Ib is greater than the basic recording bit length of the magnetically recorded information Ia. For example, as illustrated in FIG. 6, when the minimum recording bit length of the magnetically recorded information Ia is configured to have a bit pitch of 40 nm and a minimum inversion pitch of 40 nm, the ROM information Ib may be configured to have a minimum bit length of 80 nm equal to two bits and a minimum inversion pitch of 80 nm. That is, the basic bit length of the ROM information is set equal to twice the basic recording bit length in order to set the recording density of the magnetically recorded information Ia and the recording density of the ROM information Ib equal to each other.

Preferably, the signal waveforms of the magnetically recorded information Ia and the ROM information Ib are free of DC because variations in DC may make it difficult to reproduce data.

As described above, the present embodiment reads the ROM information Ib and the magnetically recorded information Ia including the contents information Io and the authentication information Ik through the head 19, and perform the DC erasure using the head 19 after the magnetically recorded information Ia is read. Further, after the DC erasure, the ROM information Ib is read, and the contents information Io is obtained from the magnetically recorded information Ia, the ROM information Ib and the authentication information Ik by the operation part 90. The contents information Io is obtained using the ROM information Ib that is allowed to be read after the DC erasure. Thus, there is no possibility that the contents information Io remains on the magnetic disk 10 after the contents information Io is read. This makes it impossible for the third party to obtain the contents information Io after the present contents information Io is read by illegal copy or the like, so that the security for the recorded information can be improved.

According to the present embodiment, the authentication process uses the authentication information Ik and the password applied externally, and controls the outputting of the contents information Io on the basis of the authentication results. It is thus possible to further improve the security for the contents information Io.

According to the present embodiment, the basic bit length of the ROM information Ib is twice the basic recording bit length of the magnetically recorded information Ia. This makes it difficult to analyze the ROM information Ib prior to the DC erasure, and makes it possible to set the recording densities of the ROM information Ib and the magnetically recorded information Ia equal to each other. It is thus possible to further improve the security for the contents information Io.

According to the present embodiment, the ECC is contained in the magnetically recorded information Ia and the DC erasure is performed when the ECC operation part 96 checks the ECC and confirms that there is no error in the read data. It is thus possible to prevent the magnetically recorded information Ia from being erased in a state in which the magnetically recorded information Ia is not obtained.

The magnetically recorded information Ia handled by the present embodiment includes the contents information Io, the authentication information Ik and ECC but may include another information in addition to these items of information or instead of any thereof. For example, the magnetically recorded information Ia may include information on position control. In this case, it is possible to supervise head access control in addition to obtaining the contents information Io.

The magnetically recorded information Ia handled by the present embodiment includes the authentication information Ik. By way of another example, the magnetically recorded information Ia does not include the authentication information Ik. In this case, the contents information Io may be output to the outside of the HDD without any authentication using the password. However, improvement in security is expected in terms of the DC erasure that is performed at the time of obtaining the contents information Io.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An information storage apparatus comprising:
a recording medium on which first information is recorded by a physical arrangement of magnetic bits and second information is recorded by magnetizing the magnetic bits;
a first reproduction part that reads third information including the first information and the second information;
an erasing part that erases the second information that is recorded on the information recording medium and is related to the third information read by the first reproduction part;
a second reproduction part that reads the first information from the magnetic bits from which the second information is erased by the erasing part; and
an information obtaining part that obtains the second information from the first information and the third information respectively read by the first and second reproduction parts.

2. The information storage apparatus according to claim 1, wherein:
the second information includes contents information and authentication information; and
the information storage apparatus further includes an output control part that executes an authentication using the authentication information and controls outputting of the contents information on the basis of an authentication result.

3. The information storage apparatus according to claim 1, wherein a basic bit length of the first information on the recording medium is twice that of the second information.

4. The information storage apparatus according to claim 1, wherein:
the second information includes an error correction code; and
the information storage apparatus further includes an erasure prohibiting part that determine whether an error in the third information is correctable by using the error correction code and prohibits the second information from being erased by the erasing part when it is determined that the error is not correctable.

5. The information storage apparatus according to claim 1, wherein the second information includes information related to a head access control.

6. A reproduction method comprising:
accessing a recording medium on which first information is recorded by a physical arrangement of magnetic bits and second information is recorded by magnetizing the magnetic bits and reading third information including the first information and the second information;
erasing the second information that is recorded on the information recording medium and is related to the third information read;
reading the first information from the magnetic bits from which the second information is erased; and
obtaining the second information from the first information and the third information.
